(19) United States
(12) Patent Application Publication
(10) Pub. No.: US 2013/0157097 A1
(43) Pub. Date: Jun. 20, 2013

(54) COMPACT FRAMELESS BIPOLAR STACK FOR A MULTICELL ELECTROCHEMICAL REACTOR WITH PLANAR BIPOLAR ELECTRICAL INTERCONNECTS AND INTERNAL DUCTING OF CIRCULATION OF ELECTROLYTE SOLUTIONS THROUGH ALL RESPECTIVE CELL COMPARTMENTS

(71) Applicants: Krisada Kampanatsanyakorn, Bangkok (TH); Suradit Holasut, Chiangmai (TH)

(72) Inventors: Krisada Kampanatsanyakorn, Bangkok (TH); Suradit Holasut, Chiangmai (TH)

(73) Assignee: SQUIRREL HOLDINGS LTD., George Town ,Grand Cayman (VG)

(21) Appl. No.: 13/805,959

(22) PCT Filed: Jun. 29, 2010
(86) PCT No.: PCT/IB2010/001651

§ 371 Date: Mar. 8, 2013

(51) Int. Cl. H01M 8/18

(52) U.S. Cl. CPC H01M 8/188
USPC 429/105

(57) ABSTRACT

A frameless bipolar cell stack architecture with either internal manifolds of circulation of electrolyte solutions “in parallel” through all respective cell compartments or internal ducting adapted to provide for “serial” flow paths of the electrolyte solutions in succession through all respective cell compartments of the stack, does not employ any plastic frame and employs substantially planar bipolar electrical interconnects (I) of substantially homogeneous electrical conductivity with a perimeter that super-imposes to the perimeter of any other element of the stack. Whenever useful for the particular application, the planar interconnects may have a protruding “lug portion” that projects beyond the outer perimeter side of the other stacked elements, providing an externally contactable area sufficiently large for the power (current rating) of an electrical tap, at an intermediate voltage relative to the voltage difference between the end terminals of the stack, connectable to an external circuit.

### TECHNICAL FIELD

The present disclosure relates generally to electrochemical cells and in particular to multicell bipolar stack reactors with internal ductings for the circulation of electrolyte solutions through respective cell compartments.

### BACKGROUND

Commonly, in bipolar cell stacks, inlet and outlet manifolds for an anolyte solution and for a catholyte solution or for a positively charged and for a negatively charged electrolyte solution are created in perimeter portions of plastic frames of two flow compartments of each cell, hydraulically separated by a permionic membrane, by alignment of through holes in the plastic frames. The anodic and cathodic flow compartments of each cells of the bipolar stack communicate with respective inlet and outlet manifolds via ductings formed through or differently defined in the plastic frames.

Sealing is commonly provided by interposing common gaskets of elastomer in form of flat gaskets or O-rings set in retaining grooves formed in the seal surface of the plastic frames.

Of course, bipolar stack electrochemical reactors used for conducting electrolytic processes with gas evolution at electrodes require proper sizing of the flow compartments, internal ducting and manifolds on account of the often remarkable volumes of gas that are generated.

There are though electrochemical processes that are conducted with no gas evolution at the electrodes and an important application among many others is for energy storage. The so-called redox flow battery or briefly redox batteries store energy in electrolytic solutions that are flown through an electrochemical multicell reactor during charge and discharge phases. The unlimited possibility of storing large volumes of electrolyte solutions make these systems exceptionally suitable for load-levelling (peak-shaving) in electric power generation and distribution industry. Most redox flow battery use a multi-cell bipolar stack. Notwithstanding the fact that the charging and discharging processes do not involve gas evolutions at electrodes, and the size of internal ducting and manifolding may be consequently reduced, the common stack architectures based on the presence of plastic frames through which creating the necessary internal manifolds and ductings to the respective electrode compartments of the cell, severely limit the possibility of compacting the overall size of the bipolar multi-cell stack.

Moreover, the electrically conductive bipolar septa whether constituting also active negative electrode and positive electrode electrodes over opposite sides of the conductive bipolar septum or acting as bipolar electrical interconnects of physically distinct positive electrode and negative electrode structures that may often be in form of conductive mats or felts compressed between a permionic membrane separator of the cell and the relative electrical interconnect on one side and on the other side thereof, is typically pre-assembled within a plastic cell frame and therefore is not accessible from exterior.

On the other hand, in many energy storage applications, it would be useful to exploit an external connectivity of bipolar interconnects of a redox flow battery as power taps at intermediate voltage, both during a charging phase and a discharge phase of the energy storage system for augmented flexibility of use and enhanced conversion efficiency.

### SUMMARY

The applicant has found an effective way of overcoming architectural limitations to the achievable compactness of common bipolar stack electrochemical reactors as well as a way of making possible to exploit any electrical conductive bipolar interconnect or bipolar electrode of the stack as an external power tap terminal connectable to an external circuit in an extremely simple manner without requiring special costly structural adaptations for preserving an effective hydraulic seal around a conductive stem adapted to external electrical connection.

The novel frameless bipolar stack architecture of this disclosure is equally suitable for making a bipolar cell stack with internal manifolds of circulation of electrolyte solutions “in parallel” through all respective cell compartments as well as for making a bipolar cell stack with internal ducting adapted to provide for a “serial” (or cascade) flow paths of the electrolyte solutions in succession through all respective cell compartments of the stack.

Basically, the bipolar multicell electrochemical reactor of this disclosure does not employ any plastic frame and employs substantially planar bipolar electrical interconnects or bipolar electrodes of substantially homogeneous electrical conductivity having a perimeter that super-imposes to the outermost perimeter of any other elements of the stack and whenever useful for the particular application may have a protruding “lug portion” that projects beyond the outer perimeter side of the other stacked elements, which, therefore, may have an externally contactable area sufficiently large for the power (current rating) of the electrical tap, at an intermediate voltage relative to the voltage difference between the end terminals of the stack, to be electrically connected to an external circuit. Consequently, also the planar bipolar electrical interconnects have through holes that provide continuity of internal manifolds or ducting for a parallel or serial flow of the two electrolyte solutions.

In case of internal manifolds for parallel flow embodiments, the hole surface and planar surfaces of the conductive interconnect in the perimeter area of abutment in hydraulic sealing with a perimeter elastomer gasket are rendered electrically non conductive by a hole lining and surface coating of an insulating material. Electrical isolation of surfaces in contact with electrolyte solutions may be established by inserting a lining ring of a suitable plastic material, for example a lining ring of polyvinyl chloride (PVC) inside the through hole and thereafter coating the perimeter areas that will be exposed to contact the electrolyte solutions on opposite sides of the planar electrical interconnect, with an adherent film of a suitable plastic material glued or hot laminated thereon to bond onto the end surfaces of the lining ring and onto said perimeter areas.

Depending on the destination of use of the bipolar multi-cell electrochemical reactor, the planar electrical interconnects or bipolar electrode plates may be of a metal sheet or of a metal laminate that may include sheets of different metals on the surfaces exposed to a catholyte solution flow compartment and to an anolyte solution flow compartment, or of an electrically conductive aggregate of particles of conductive material (metal, carbon, etc.), a graphite plate, a plate of glassy carbon or of a composite laminate including metal foils and non metallic conductive layers.

Particularly in redox flow battery systems, pumping of the electrolyte solutions through the respective cell compartments of compact bipolar cell stacks, detracts from the overall energy conversion efficiency of the energy storage system because of the electrical power absorbed by the pumps during charge and discharge phases. Moreover, pumping is usually controlled in function of the voltage present at the cell or stack terminals in order to maximize energy storage during a charge phase and ensure maintainment of an adequate output DC voltage during a discharge phase. Therefore, the pumps must occasionally be driven at increased power to prevent depletion of electrolyte at the cell electrodes in case a relatively large current through the electrochemical cells must be supported (i.e. an increased current density over the active cell area).

For these reasons, while serial or cascade flow path of the catholyte solution and of the anolyte solutions in succession through the respective cell compartments starting from an inlet header compartment to an outlet header compartment of the bipolar cell stack, as disclosed in the document WO 01/03224-A1, of the same applicant, eliminates the so-called by-pass or stray currents plaguing the traditional bipolar cell stack architectures with inlet and outlet manifolds for each of the two electrolyte solutions for flowing the respective electrolyte solution in parallel through all the relative cell compartments of the stack, it implies augmented hydraulic losses that may be incompatible (because of their decrementing effect on the overall energy storage efficiency) if the energy storage system is destined to function almost constantly at relatively large current densities, as for example in peak-shaving installations of an electrical distribution grid.

Vice versa, in isolated non-grid connected energy conversion plants from renewable sources such as solar or wind energy conversion plants, wherein the redox flow energy storing system may be normally called to operate in prolonged low or moderate power input storing phases and similarly in prolonged low to moderate power supplying phases to local electrical loads, bipolar cell stack with serial flow path of the electrolytes through the respective cell compartments, may remain a preferable choice from the point of view of energy storage efficiency and of reliability and operative life of the cell stack.

The invention is defined in the annexed claims, the recitation of which is to be intended constituting part of this specification.

### BRIEF DESCRIPTION OF THE DRAWINGS

FIG. 1 is a schematic exploded detail view of a permionic membrane assembly arrangement of the bipolar cell stack architecture of this disclosure.

FIG. 2 is a schematic exploded detail view of one end of bipolar cell stack.

FIG. 3 is a schematic exploded three-dimensional view of a frameless bipolar cell stack with internal manifolds for parallel electrolyte solution flows of this disclosure.

FIG. 4 shows a detailed exploded view of a laminated embodiment of a planar electrical conductive cell interconnect.

FIG. 5 is a partial detail cross section of the laminated interconnect of FIG. 4.

FIG. 6 and FIG. 7 are views from opposite sides of one of the pair of identical gaskets of the permionic membrane assembly arrangement of this disclosure for a bipolar cell stack with internal manifolds for flowing the electrolyte solutions in parallel through the respective flow compartments of all the cells of the stack, according to the embodiment of FIG. 3.

FIG. 8 is an exploded detail view of the permionic membrane assembly arrangement of the bipolar cell stack architecture of the disclosure according to another embodiment.

FIG. 9 is a schematic exploded three-dimensional view of a frameless bipolar cell stack architecture with internal ducting for flowing serially (in cascade) the electrolyte solutions through the respective flow compartments of all the cells.

FIG. 10 and FIG. 11 are views from opposite sides of one of the pair of identical gaskets of the permionic membrane assembly arrangement of this disclosure for a bipolar cell stack with internal ducting for flowing the electrolyte solutions in succession through the respective flow compartments of all the cells of the stack, according to the embodiment of FIG. 9.

FIG. 12 is a schematic view of a segmented stack of bipolar cells with internal manifolds for parallel flow of the electrolyte solutions serving a limited number of bipolar cells of a group, and intermediate voltage taps.

FIG. 13 is a schematic view of a segmented stack of bipolar cells with internal ducting for serial flow of the electrolyte solutions and intermediate voltage taps.

### DESCRIPTION OF EXEMPLARY EMBODIMENTS

An important feature of the novel frameless multicell bipolar electrochemical reactor structures of this disclosure is represented by the manner in which the permionic membrane hydraulic separator between the distinct flow compartments of each electrochemical cell is installed, or in other words by the permionic membrane assemblies that interleave with substantially planar electrically conductive bipolar elements or plates of substantially homogeneous conductive material, in order to be eventually compressed together between ordinary headers of the stack, for hydraulically sealing the flow compartments of all the cells in electrical series of the bipolar stack and define internal manifolds and ducting.

In a first exemplary embodiment depicted in the exploded detail view of a membrane assembly according to the present disclosure, the depicted gaskets have bas-relief patterned seal areas and through holes, adapted to constitute a bipolar stack with internal manifolds and ducting for flowing the two electrolyte solutions in parallel through the respective flow compartments of all the cells of the stack or of groups of cells of the stack (as will be later described). Of course, as will become evident in the ensuing description, the same assembly arrangement is used with gaskets having a different pattern of bas-relief seal areas and different number of through holes for making a bipolar stack with internal ducting adapted to flow the two electrolyte solutions distinctly through the respective flow compartments of all the cells of the stack, or of groups of cells, in succession from a first cell compartment at one end to a last cell compartment at the opposite end of the stack.

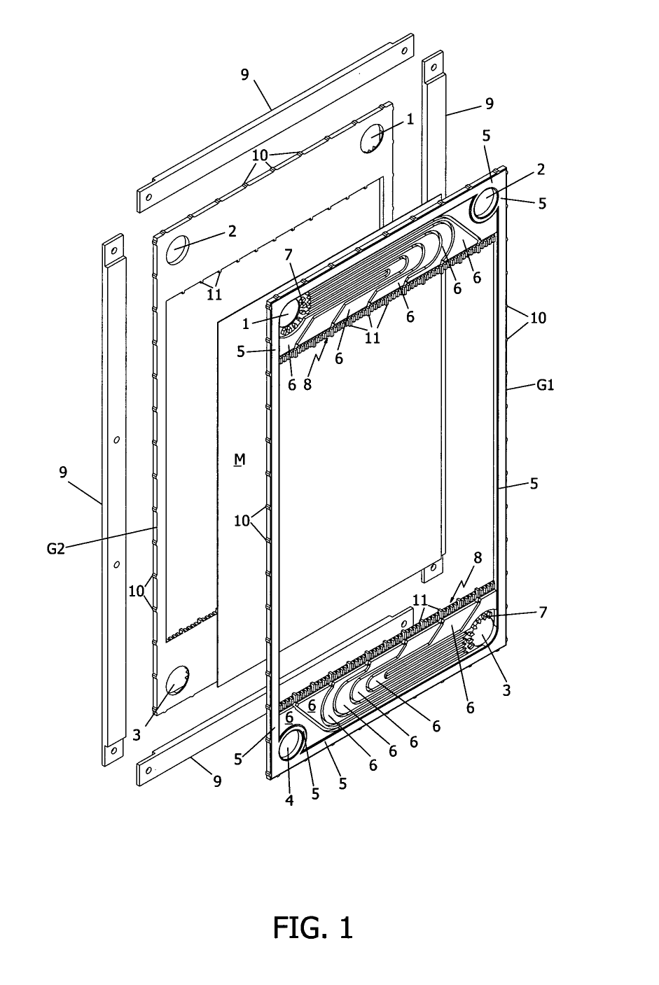

Referring to FIG. 1, the permionic membrane M, commonly a flexible film of an ion exchange polymer adapted to exchange anions, cations or both, depending on the destination of use of the electrochemical reactor, has its perimeter portion sandwiched between two identical parallelepiped elastomer gaskets G1 and G2 disposed back-to-back. The so composed membrane assembly is eventually compressed between two planar electrical interconnects or bipolar electrodes plate (not shown in FIG. 1) upon tightening the stacked elements together.

The two identical gaskets G1 and G2 define a central aperture or window closed by the membrane M that has perimeter edge portions sealingly held between essentially flat seal surfaces of the back side of the two identical gaskets, thus providing for the required hydraulic separation between the flow compartments of the cell, on one side and on the opposite side, respectively, of the permionic membrane M.

Therefore, the active cell area will practically correspond to the area of the central aperture defined by the two gaskets G1 and G2.

For the exemplary embodiment shown in FIG. 1, the gaskets have four through holes, 1, 2, 3, 4, that, coherently to the fact that the two gaskets are identical but disposed back-to-back, are indicated by corresponding numbers. The four holes, once the stack is completed and tightened, will form, together with similarly aligned through holes in the bipolar electrical interconnects, internal inlet and outlet internal manifolds of circulation of the two electrolyte solutions in the respective cell compartments of all the cells, in parallel.

As observable for the visible face of the gasket G1, the “front side” (as opposed to the backside) of the gaskets have a bas-relief patterned perimeter seal area 5 that has loops adapted to contour completely the through hole 2 and the diametrically opposite through hole 4.

Over two opposite sides of the central aperture there are two similar pluralities of patterned seal areas that define therebetween elongated split flow channels 6 that extend from a rim region 7 of non-contoured through holes 1 and 3 at the other diagonally opposite locations of the membrane.

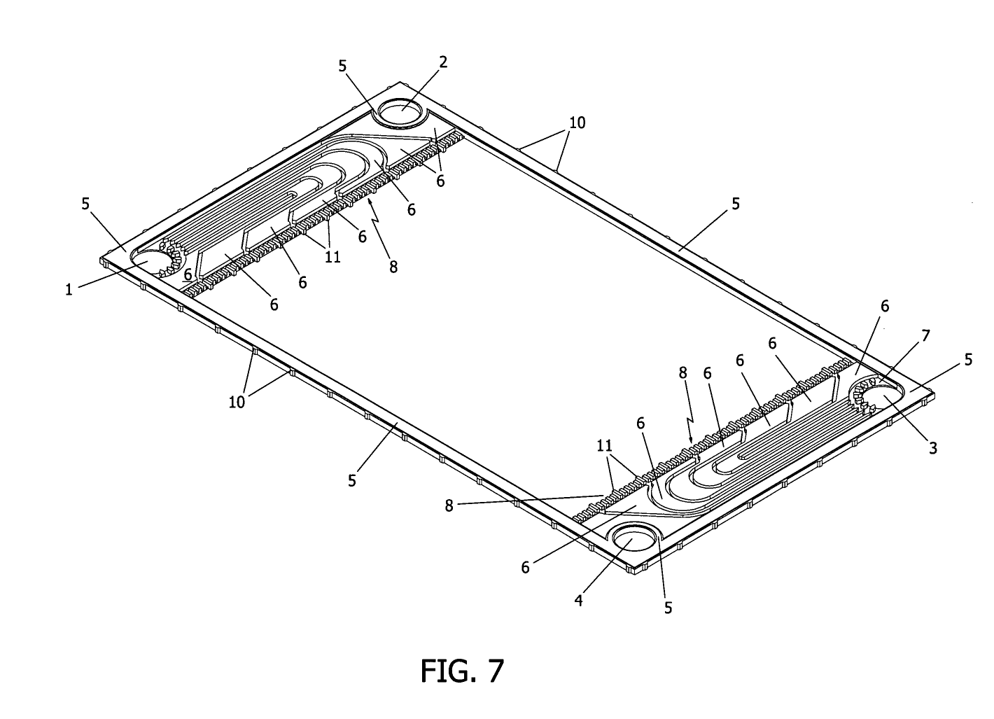

According to the particular embodiment for parallel flow depicted in FIG. 1-to-FIG. 7, the parallel split flow channels 6 are tortuously elongated, at art, in order to define distinct flow channels each comprising at least a narrow elongated tract along which the electrolyte solution is forced to flow through, both: before reaching a respective “inlet zone” at the edge of one side of the central aperture and entering the flow compartment of the cell, passing through the gaps between relatively short patterned seal areas 8, forming a comb-like linear array, and vice versa, upon entering a respective “outlet zone” at the edge of the opposite side of the central aperture of the gasket defining the flow compartment (electrode compartment) of the cell. In practice, the two patterned seal areas on the front side of each gasket define tortuously elongated split flow channels 6, such to have al least a tract relatively narrow and long to provide for a sufficiently increased electrical resistance to by-pass (stray) ionic currents through the electrolyte solution in the respective inlet and outlet internal manifolds of the bipolar cell stack toward electrode or other electrically conductive surfaces of nearby and increasingly distant cells of the stack at progressively large voltage differences.

In the present disclosure, with the expression “tortuously” it is intended to point out that the actual layout of the split flow channels 6 may assume innumerable geometrical shapes, more or less tortuous depending on the characteristics of the electrolyte and of critical current density of ion discharge of the electrically conductive materials used for the electrodes and for the bipolar interconnects exposed to contact with the electrolyte solution.

The narrow cross sectional elongated tracts of the channels of split flow of the electrolyte solution augments the electrical resistance to ionic currents in the electrolyte solution to and from a cell compartment of the serially connected bipolar cells toward electrically conducting surfaces of compartments of other cells under increasingly large voltage differences, in order to limit such by-pass or stray currents and prevent surpassing a critical current density of ion discharge over conductive parts of the cells of the stack through the internal manifolds, that if surpassed would in some cases corrode the conducting part by an intervening anodic oxygen discharge thereon, for example, as well known to the skilled person.

Of course, all patterned seal areas at the top of the salient portions defined over the front side of the elastic gaskets have the same height, being destined to press against a substantially planar surface of the bipolar electrically conductive elements. Therefore, the patterned salient parts of elastomer over the front side of the gasket besides establishing a hydraulic seal over the counter-opposed surface of the bipolar interconnects, define electrolyte flow ducting channels and the compartment void through which the electrolyte solution flows.

In many important applications, typically for a redox flow storage battery system, the active electrodes may be compressible mats or felts of carbon fibers disposed in both flow compartments of every cell in electrical contact with the electrically conductive bipolar interconnect. The mat or felt electrodes constitute porous electrode through which the electrolyte solution may flow in a “lateral” direction from an inlet side of the flow compartment to the opposite outlet side of the compartment, providing for an augmented active electrode surface adapted to sustain the electrochemical reaction at the electrode at relatively large current densities, referred to the cell area. Though conductive adhesives may be used to enhance electrical conductivity through the bipolar electrode assembly composed of the mat or felt electrodes in contact with opposite surfaces of the electrical interconnect, the electrical contact may also be ensured by a moderate compression of the mat or felt electrodes between the membrane separator and the bipolar interconnects, upon tightening the stack.

Specially for bipolar cell stacks composed of a large number of cells, it would be difficult to guarantee that all the elastomer gaskets be equally and uniformly compressed. In order to ensure maintainment of parallelism between the planar conductive bipolar elements pressed against the two-elastomer gasket membrane assemblies interleaved there between, and a precisely defined identical void space to all the flow compartments of the cells upon tightening the stack, each two-gasket membrane assembly is contoured by plastic spacers 9 having a thickness corresponding to a designed maximum compression of the elastomer gaskets between the bipolar interconnects, adapted to reliably secure all hydraulic seals defined by the bas-relief patterned elastomer gaskets, form leak proof internal manifolds and split flow ducting 6, and at the same time avoid localized over compression of the elastomer gaskets and/or the compressible mat or felt electrodes, if present there between, making the bipolar interconnects perfectly parallel to each other and equally spaced.

In the embodiment shown in FIG. 1, the spacers 9 may be in the form of four strip spacers, adapted to be joined at the four corners, to constitute a perimetral spacer contouring the outer perimeter of the two gaskets G1 and G2.

Spaced protrusion 10 along the entire outermost perimeter of the gaskets G1 and G2, provide for a certain spacing from the juxtaposed spacers 9, leaving uniform gaps for a limited and uniform lateral expansion of the perimeter of the elastomer gaskets upon compressing them.

Similarly spaced protrusions 11 are also formed along the inlet and outlet sides of the central aperture of the gasket, by defining several spaced protruding comb-teeth every so many in the two linear teeth arrays 8 defined along the inlet and outlet sides of the central aperture or window of the gasket, in order to limit the lateral expansion of the electrode mat or felt (if present) upon compressing it, for preventing it from unchecked swelling to the point of clogging inlet and outlet flow passages between adjacent parallel teeth of the comb-like arrays of the electrolyte solution, in and out of the flow compartment.

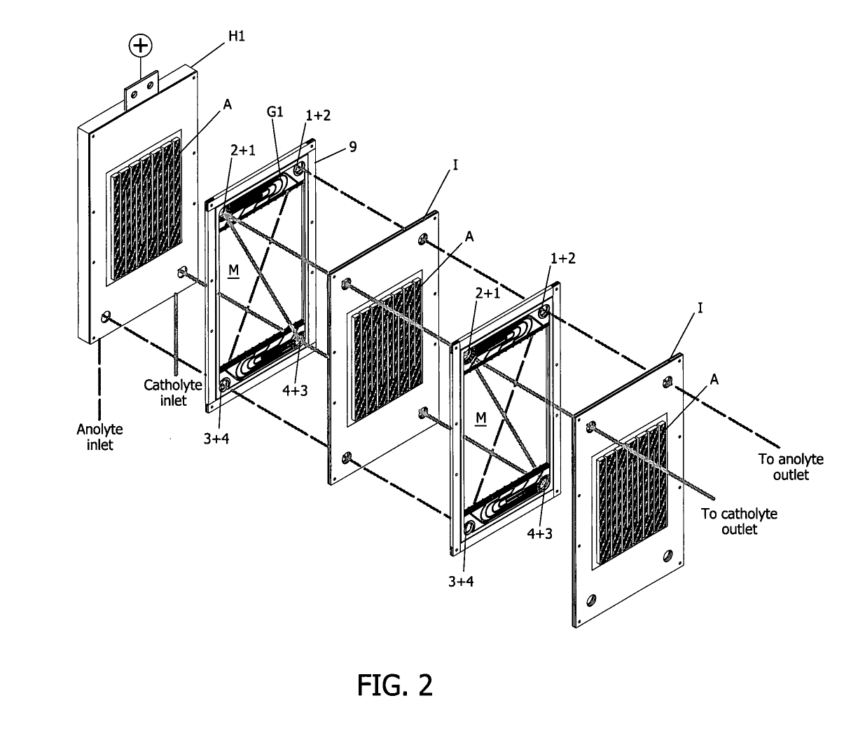

FIG. 2 is a schematic exploded view of one end of bipolar cell stack including one header H1 that, in the example shown, is a terminal positive electrode unit having a compressible felt positive electrode A. In the header H1 are defined the inlets of the anolyte and of the catholyte solutions that circulate respectively in the flow compartments “behind” (from the point of observation) the membrane assemblies M of the bipolar cells, to be collected in the diagonally opposite internal manifold leading to an anolyte outlet in the header at the opposite end of the stack. The catholyte solution flows through the flow compartments “in sight” of the bipolar cells, to be collected in the diagonally opposite internal manifold leading to a catholyte outlet in the header at the other end of the stack. In case of a redox flow battery the denomination of anolyte and catholyte refers to a discharge phase of operation of the multi-cell bipolar stack.

These denominations of the two electrolyte solutions should be exchanged during a charge phase of operation, because of the inversion of the electric current through the cells in series.

The permionic membrane separator M of the cells is shown as being a non tranparent film held between the two gaskets of the membrane assemblies, of which only the front side gasket G1 in sight in the drawing. The negative electrode felts on the rear side of the interconnects I are not in sight in the drawing.

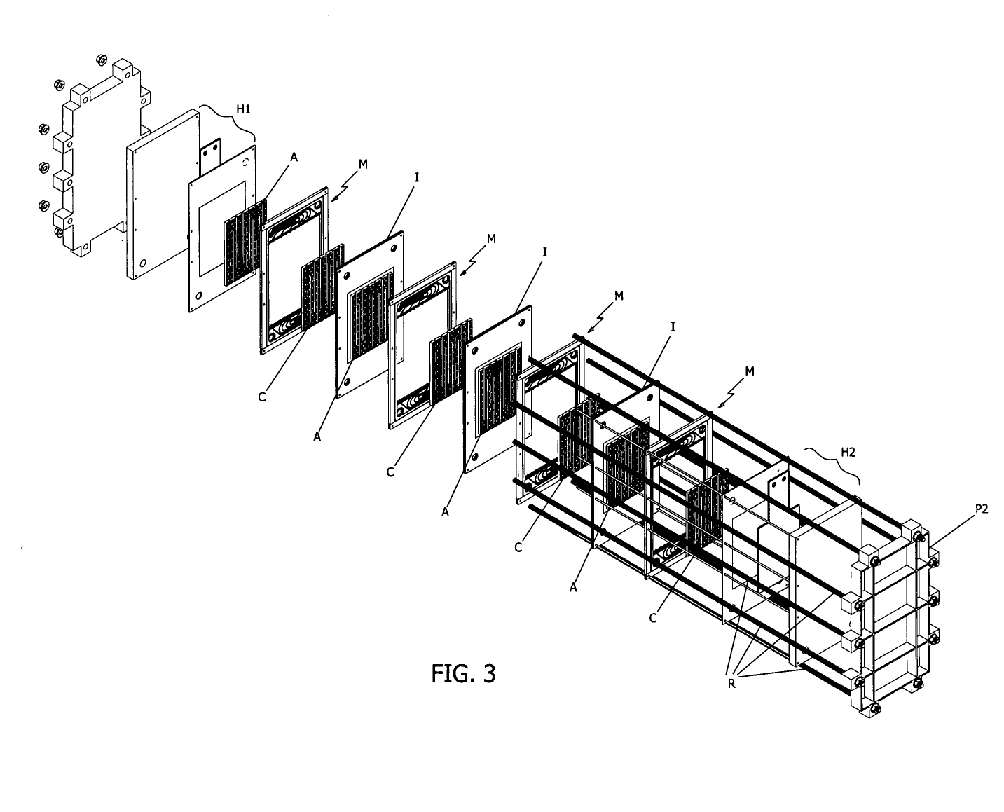

FIG. 3 is a schematic exploded view of a complete bipolar cell stack showing an exemplary structure of the two headers H1 and H2, the positive electrode felts A and negative electrode felts C as well as the compression stress structure including two stiff end blocks P1 and P2 and the plurality of tie rods R for tightening stacked elements there between, according to common “filter-press” like organization of bipolar electrochemical cell stacks.

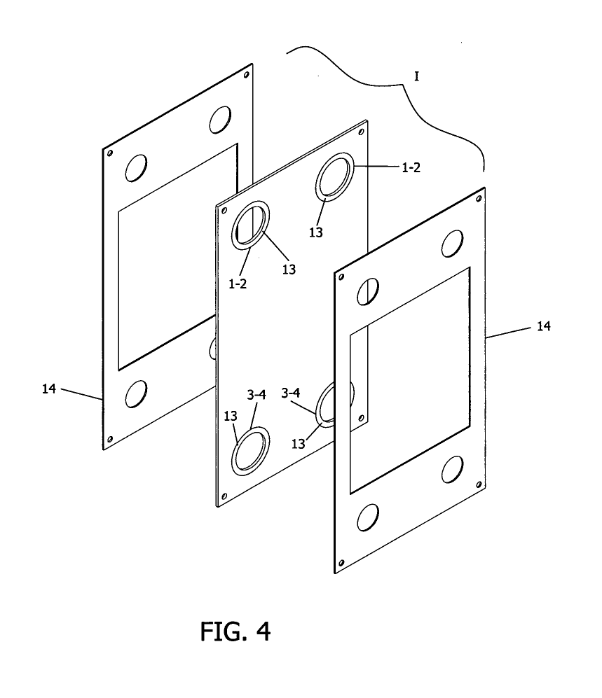

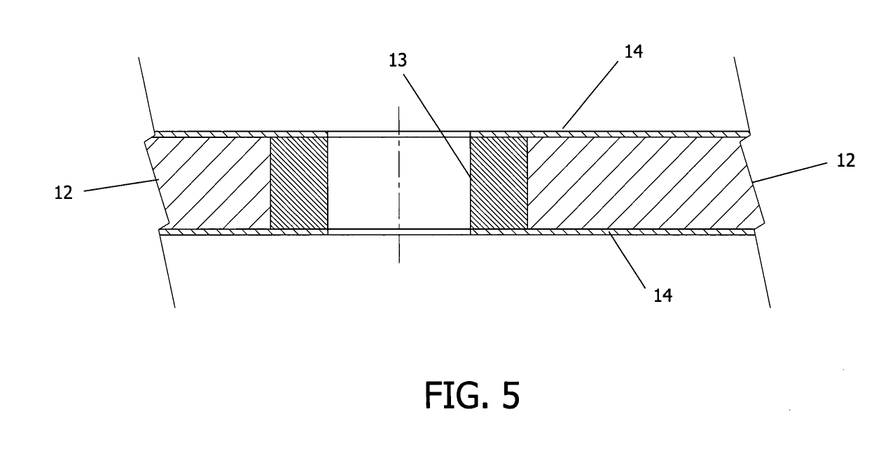

An exemplary laminated bipolar interconnect I, particularly adapted for redox flow battery stacks in association with a felt electrode of carbon fibers is illustrated in FIG. 4 and FIG. 5.

As shown in the exploded view of FIG. 4, the planar electrically conductive bipolar interconnect body 12 may be of an electrically conductive aggregate of particles of graphite and/or carbon and a resin binder that may be a thermosetting resin, for example an epoxy base resin, or even a hot moldable polyester or a polyolefin resin binder. In order to increase lateral conductivity toward a perimeter lug extension, the conductive body if made of an aggregate, may incorporate a metal foil, a metal or carbon fiber gauze or an expanded metal sheet as a high conductivity core layer completely embedded in the laminated or molded aggregate

The conductive body 12 may be in the form of a relative thin sheet of aggregate of sufficient stiffness once it is eventually cut to size, through which the four through holes (for the considered embodiment) 1-2 and 3-4 are drilled, such to geometrically match (align) with the through holes 1, 2 and 3, 4 of the gaskets G1 and G2.

Rings 13 of a suitable plastic material, for example PVC, are set into the drilled holes to constitute an electrically non conductive lining of the flow passages through the conductive bipolar interconnect 12.

Also the perimeter surfaces destined to be compressed against all the seal areas of the bas-relief patterned front faces of the elastomer gaskets of the membrane assemblies belonging to two adjacent cells of the stack, may be rendered electrically nonconductive by laminating over the opposite sides of the electrically conductive interconnect 12, appropriate masking films 14 of a suitable electrically insulating material, generally a plastic film. The electrically insulating mask film may be glued onto the surface of the electrically conductive interconnect 12 or hot laminated thereon in order to bond to the plastic matrix of the aggregate of the interconnect or alternatively the same result may be obtained by applying an insulating enamel using an inverted application mask for spraying the insulating enamel.

In any case, as shown in the partial detail cross section of FIG. 5, insulating surface films 14 overlay and are bonded onto the end surfaces of the lining ring 13 in order to secure isolation from contact with the electrolyte solution the so coated areas of the electrically conductive interconnect 12.

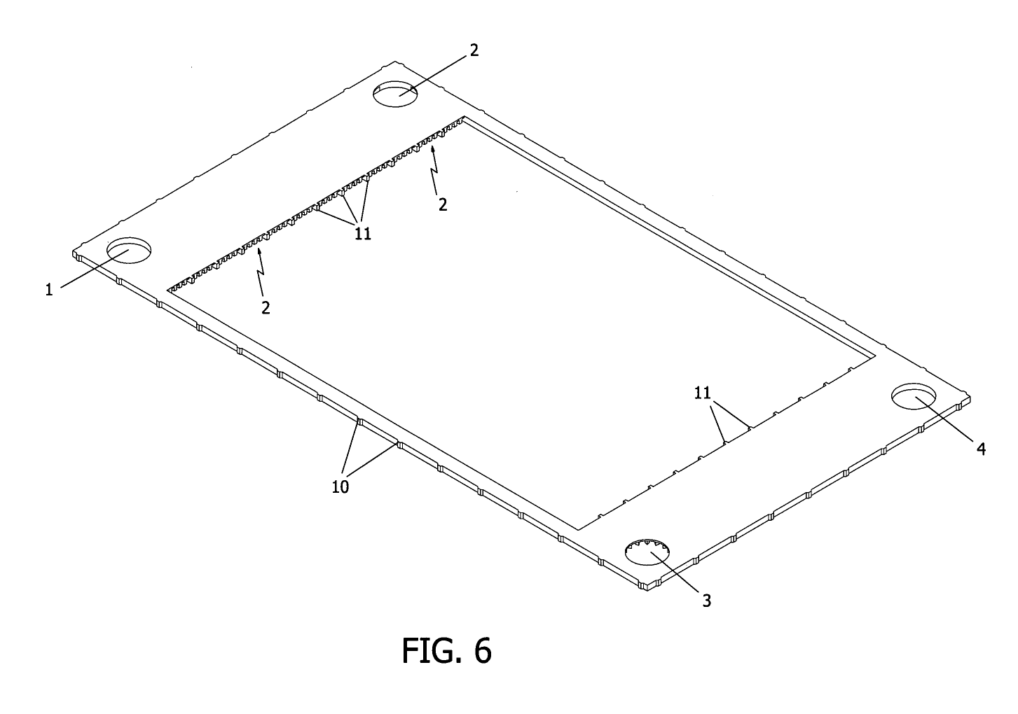

FIG. 6 and FIG. 7 are three-dimensional views of the backside end of the bas-relief patterned front side, respectively, of the gasket of the embodiment illustrated in FIGS. 1 to 3.

In the front side view of FIG. 7, are clearly observable the split flow channels 6, that distribute the electrolyte solution coming from the inlet manifold to the inlet side of the central aperture of the gasket, entering the flow compartment passing through the uniformly spaced linear array 8 of parallel seal areas atop the bas-relief defined short parallel segments disposed in a comb-like manner along the inlet side, and the split flow channels 6, that similarly collect the electrolyte solution at the opposite outlet side of the cell compartment wherein it flows into the split flow channels 6 leading to the respective outlet manifold. As may be observed, the two bas-relief patterned areas along the opposite sides of the parallelepiped membrane are substantially identical though overturned. In FIG. 7 may also be observed more clearly the elongated narrowed tracts of each of the split flow channels 6 adapted to limit the by pass (stray) currents (ionic) in the electrolyte solution from the electrode of one compartment toward electrically conductive parts of same compartments of other cells and vice versa.

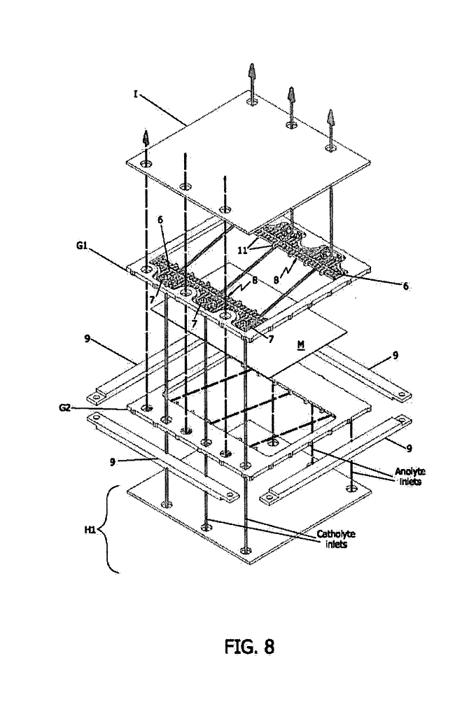

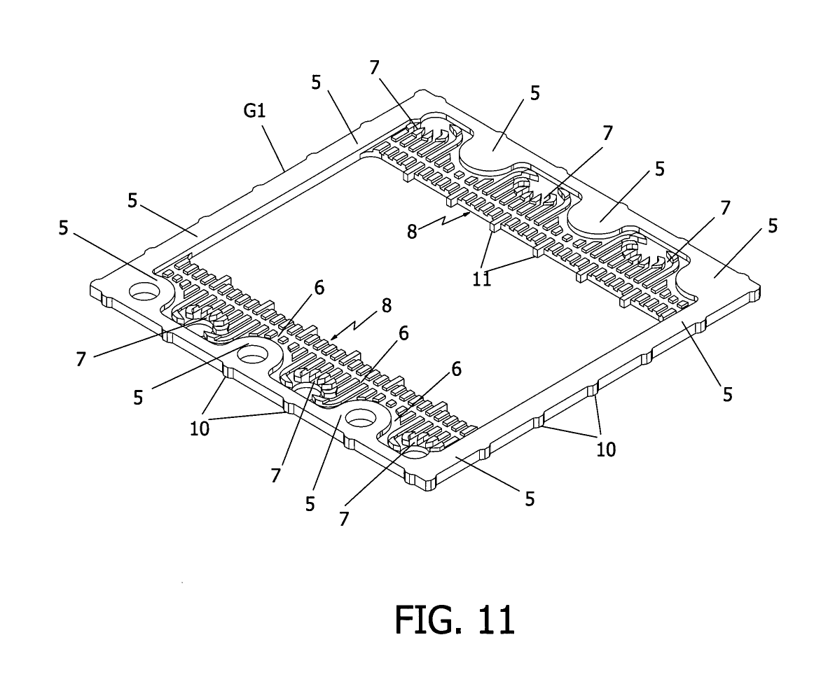

An alternative embodiment of the bipolar cell stack architecture of this disclosure is depicted in FIG. 8-to-FIG. 11.

According to this alternative embodiment, the problem of by-pass (stray currents) in bipolar cell stack is practically eliminated by flowing the electrolyte solutions through the respective cell compartments of the stack in succession and not as traditionally done, in parallel. In this way, there are no by-pass ionic current path through the internal manifolds.

As will be evident from the ensuing description and related drawings, also or this alternative embodiment, the same permionic membrane assembly arrangement of FIG. 1 is used together with similar planar electrically conductive bipolar elements, placed against the bas-relief front side of the two gaskets of the membrane assembly. The difference is in the differently coordinated through holes in the bas-relief patterned perimeter areas of the opposite two perimeter sides delimiting the central aperture of the identical parallepiped elastomer gaskets G1 (G1ₜ) and G2 (G2t), and in the counter opposed electrically conductive interconnects I.

Because of the peculiar organization of internal ducting according to this embodiment, the exploded detail view of a permionic membrane assembly of FIG. 8, includes also the two electrically conductive planar interconnects in order to illustrate the peculiar coordination of through holes in the elastomer gaskets G1t and G2 and in the cooperating terminal interconnect H1 and bipolar interconnects I. In order to illustrate the differences of the two terminal gaskets (G1t and G2t) from all the other gaskets G1 and G2, respectively, the sequence of stacked elements shown in FIG. 8 is of a first terminal cell of the stack, in other words the cell partly composed by one header of the stack. In this embodiment, the terminal elastomer gaskets G2t, may not have through holes in one of the two bas-relief patterned perimeter sides of the gasket. Of course, at the other end of the stack, there will be a similar terminal gasket (G1t) without through holes along one perimeter side thereof.

The flow arrows of the two electrolyte solutions indicate how the coordination of through holes in the two gaskets G1t and G2 of this first membrane assembly and in the counter opposed electrically conductive elements H1 and I, defines internal ducting that conducts each electrolyte solution to flow in succession from a first respective flow compartment of a first cell, serially into the respective flow compartment of all the other cells, as far as the last cell at the opposite end of the stack, from where the electrolyte solution exits the bipolar stack.

Another difference from the first embodiment is represented by a different layout of the bas-relief patterned perimeter seal areas on the front side of each gaskets G1 and G2, wherein the pluralities of patterned seal areas no longer define tortuously elongated split flow paths, in consideration of the fact that in this embodiment there is no concern about the problem of by-pass (stray) ionic currents. Therefore, the similar pluralities of patterned seal surfaces include a perimeter seal area 5, forming loops that completely contour one every two through hole along the two opposite perimeter sides, while the short, uniformly spaced, generally parallel seal areas atop patterned parts of elastomer, define there between flow passages leading from the rim area of non contoured (sealed off) through holes to the nearby inlet perimeter side of the flow compartment of the cell and similar short, uniformly spaced, generally parallel seal areas atop patterned parts of elastomer on the other outlet perimeter side that define there between flow passages leading to the rim area of non contoured through holes.

According to this embodiment, the coordination of the through holes of the gaskets of each permionic membrane assembly with the through holes of the respective electrically conductive interconnects or bipolar electrode plates is such that the through holes along one perimeter side of the interconnect match (are aligned with) the non contoured through holes of the bas-relief patterned gasket, while the through holes along the opposite perimeter side of the interconnect match (are aligned with) the contoured through holes of the gasket.

Therefore, the through holes in the interconnects are generally half the number of through holes of the elastomer gaskets. Moreover, for enhanced uniformity of distribution of the electrolyte to an extended porous electrode structure, more than two through holes on each of the opposite perimeter sides can be present in this embodiment based on a serial flow of the electrolyte solutions through the bipolar cell stack.

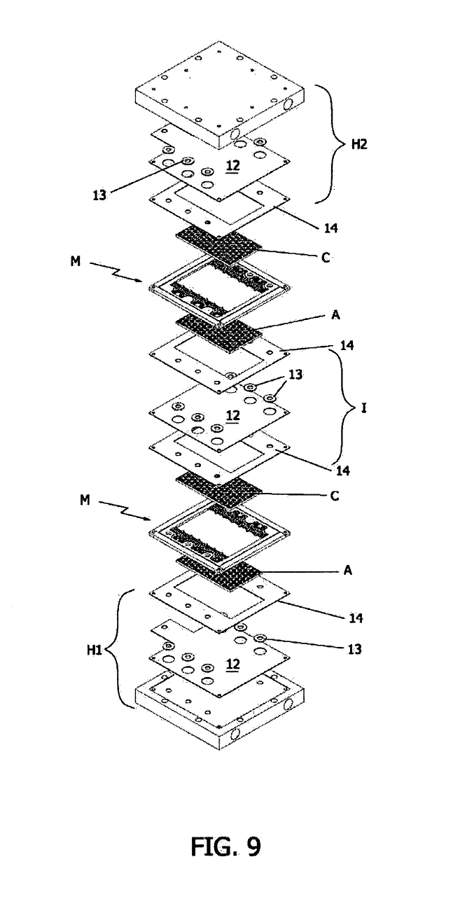

FIG. 9 shows an exploded schematic view of a bipolar cell stack with internal ducting establishing a serial flow of the two electrolyte solutions (in succession through the respective flow compartments of all the cells of the stack.

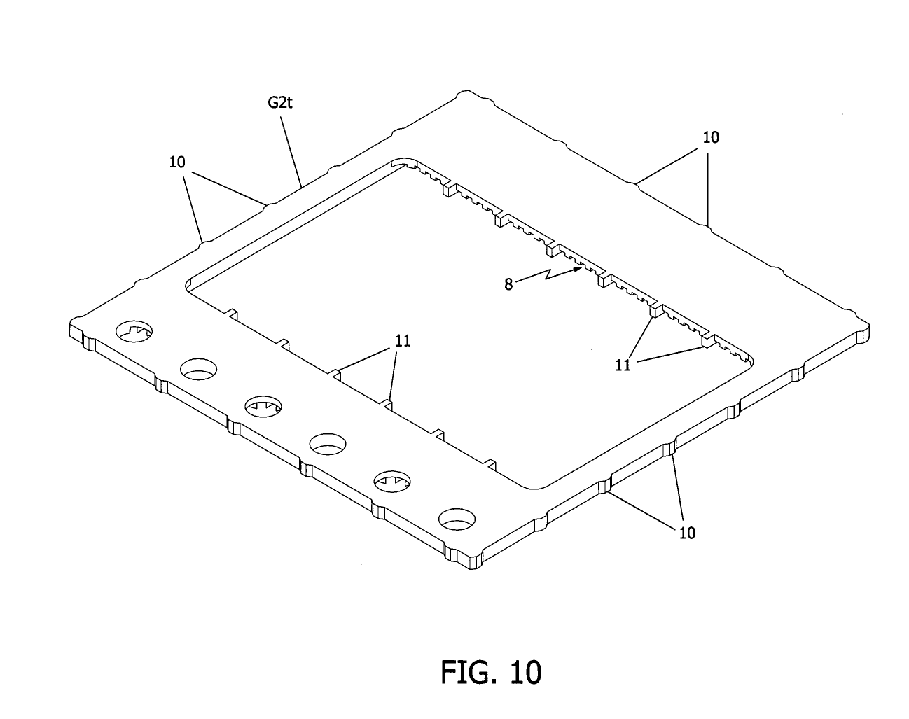

FIG. 10 and FIG. 11 are three-dimensional views of the backside end of the bas-relief patterned front side, respectively, of the gaskets of a first membrane assembly for a first cell of the bipolar cell stack according to the embodiment illustrated in FIG. 8. The two views make clearly observable the fact that the end gasket G1t of the stack that cooperates with a counter opposed electrically conductive interconnect part of a header (H1) has though holes, contoured and non contoured, only along one of the opposite perimeter sides (the holes in the other perimeter side may be blind). By contrast, all other gaskets of the stack, whether G1 or G2 of all the membrane assemblies, are perfectly identical to the shown G2 of FIG. 11, except the ones (G1t and G2t) at the two ends of the stack, have open through holes in both the perimeter sides.

In the front side view of FIG. 11, are clearly observable the pluralities of intercommunicating flow channels 6 among the short flow deflecting baffles of the patterned elastomer seal areas that direct the electrolyte solution coming from each inlet hole toward the inlet side of the central aperture of the gasket, finally entering the flow compartment passing through a last uniformly spaced linear array 8 of parallel seal areas atop the bas-relief defined short parallel segments (acting as flow deflectors or baffles) disposed in a comb-like manner along the inlet side, and the pluralities of intercommunicating flow channels 6, that similarly redirect the electrolyte solution at the opposite outlet side of the cell compartment wherein it flows toward respective outlet holes. As may be observed, the two bas-relief patterned areas along the opposite sides of the parallelepiped membrane are substantially identical though overturned.

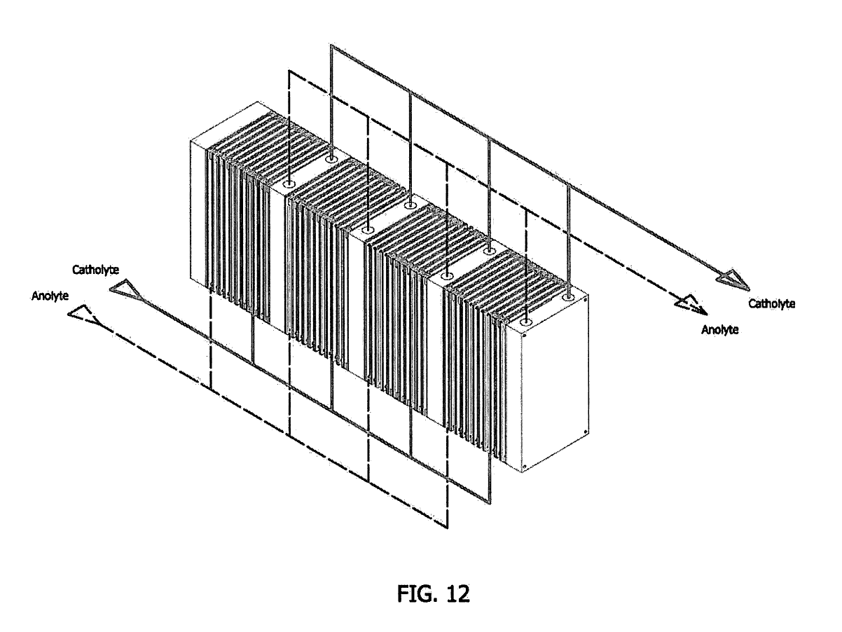

For applications where it is of paramount importance that power consumption for pumping the electrolyte solutions through the bipolar multi cell stack be minimized, and a parallel flow stack be used, the problem of by-pass (stray) currents may be considerably lessened by the special bipolar cell stack architecture depicted schematically in FIG. 12.

According to this embodiment, a multicell bipolar stack with internal manifolds for conducting a parallel flow of the electrolyte solutions through all the respective cell compartments of the stack, has a segmented structure based on the use of a certain number of “intermediate headers” (double-face structured headers that are coupled at both sides) H between the two end headers H1 and H2 of the stack.

Each of the intermediate headers H has a bipolar or double-face structure in order to function as would-be end headers of groups of bipolar cells on one side and on the opposite side of the intermediate header.

Hydraulically the intermediate headers permit to the two electrolyte solutions flown in parallel through the respective compartments of a preceding group of bipolar cells to exit the stack from the outlet ports of an intermediate header to be collected in external primary manifolds from and to respective electrolyte solution tanks in case of an energy storage redox flow battery system.

Each group of bipolar cells may have a number of cells adapted to generate, for example, about 12V, therefore the driving voltage differences of by-pass (stray) currents within each group of cells sharing internal manifolds of distribution of the two electrolyte solutions, remain relatively small. This fact, coupled to the tortuously extended split flow paths of the electrolyte solutions in entering and exiting the respective cell compartments ensure conditions of non surpassing critical discharge current densities on conductive surfaces in the cell compartments of the particular group of cells. The segmentation of the stack with intermediate headers, further allows to exploit the availability of voltage taps connectable to external circuits at different voltages (for example 12V, 24V, 36V and 48V).

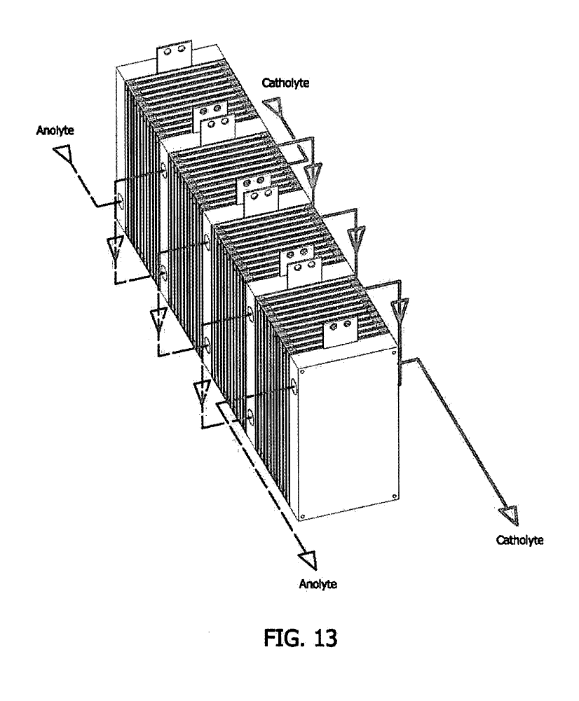

Of course a similar segmentation of a bipolar cell stack for power taps at different voltages may also be implemented with a serial flow stack. FIG. 13 is a schematic view of a segmented stack of bipolar cells with internal ducting for serial flow of the electrolyte solutions and intermediate voltage taps.

It is remarked the fact that all the connectable voltage taps of the stacks may be simply constituted by perimeter lug extensions of the planar electrically conductive interconnects, without requiring any complex sealing of an electrical connection stem protruding out of a plastic frame as was common in prior art bipolar stacks

Provision of power switches, permits to adapt interconnections among the available voltage taps for best suiting electrical power distribution requirements.

1. A frameless multi-cell bipolar electrochemical reactor composed of stackable elements between two headers, hydraulically sealed by compressing the stacked elements, including planar bipolar electrical conductive elements alternated to a permionic membrane assembly fixture adapted to separate anodic and cathodic solution flow compartments defined between said permionic membrane separator and one and the other of said bipolar electrical elements and through which the two distinct electrolyte solutions are respectively flown, comprising
two identical parallelepiped elastomer gaskets defining a central aperture and having at least two through holes along two opposite perimeter sides thereof, a flat perimeter seal surface on a backside and on the opposite or front side thereof: a bas-relief patterned perimeter seal area contouring one every two through holes along said two opposite perimeter sides and two similar pluralities of patterned seal areas defining there between flow channels extending from a rim region of non-contoured through holes to the edge of the nearest juxtaposed side of said central aperture of the gasket;
the permionic membrane having perimeter edge portions sealingly held between said flat perimeter seal surfaces of the two identical gaskets, disposed back-to-back;
the bas-relief patterned seal areas over the front side of the two identical gaskets, compressed between the surfaces of respective planar electrically conductive bipolar elements in alignment with the through holes of the gaskets for hydraulically sealing the perimeter of the two flow compartments in hydraulically communication with through holes non-contoured by said perimeter seal area of the patterned front side of the respective gasket.

2. The frameless multi-cell bipolar electrochemical reactor of claim 1, wherein said planar bipolar elements are electrical interconnects of the cells and said anodic and cathodic compartments contain conductive felt or compressible mat anodes and cathodes, respectively, compressed between the permionic membrane separator and a respective planar bipolar conductive interconnect and said permionic membrane assembly includes non-conductive perimeter spacers adapted to limit compression of said bas-relief patterned elastomer gaskets and maintain parallelism among the stacked elements upon tightening them together.

3. The frameless multi-cell bipolar electrochemical reactor of claim 1, wherein said planar electrically conductive bipolar elements have a perimeter adapted to overlap the outermost perimeter of said gaskets and optionally include a protruding lug portion that projects beyond the outer perimeter side of the gaskets for electrical connection to an external circuit.

4. The frameless multi-cell bipolar electrochemical reactor of claim 1, wherein said planar conductive bipolar electrodes or interconnects are of homogeneously conductive material and the surfaces of the holes there through and planar surfaces over which seal areas of the counter opposed patterned elastomer gasket press have a nonconductive coat.

5. The frameless multi-cell bipolar electrochemical reactor of claim 1, with internal inlet and outlet manifolds for flowing said electrolyte solutions in parallel through all the respective cell compartments, comprising
two identical parallelepiped elastomer gaskets defining a central aperture and having two through holes, respectively at the two corner ends, of said opposite perimeter sides thereof, a flat perimeter seal surface on a backside and the opposite or front side thereof: a bas-relief patterned perimeter seal area contouring one through hole of one of the opposite perimeter sides and the diametrically opposite through hole of the other perimeter side and two similar pluralities of patterned seal areas defining there between tortuously elongated channels originating from a rim region of the two diagonally opposite through holes non-contoured by said perimeter seal area and reaching spaced points along said nearest juxtaposed side of said central aperture of the gasket, respectively;
planar conductive bipolar electrodes or interconnects having through holes at the four corners matching with the two gaskets in sealing therebetween an anode flow compartment and a cathode flow compartment communicating with respective inlet and outlet internal manifolds constituted by said diagonally opposite through holes respectively.
said permionic membrane having perimeter edge portions sealingly held between said flat perimeter seal surfaces on the back side of the identical gaskets, disposed back-to-back;
said bas-relief patterned seal areas over the front side of the two identical gaskets compressed between the surfaces of respective planar electrically conductive bipolar elements having through holes in alignment with the through holes of the gaskets for hydraulically sealing the perimeter of the two flow compartments communicating with respective inlet and outlet internal manifolds through said non contoured holes of the respective gasket.

6. The frameless multi-cell bipolar electrochemical reactor of claim 5, wherein the length of said tortuously elongated parallel split flow channels of electrolyte solution is such to prevent ion discharge current densities exceeding a critical maximum value over conductive parts of other cells.

7. The frameless multi-cell bipolar electrochemical reactor of claim 1, with internal ducting for flowing said electrolyte solutions in series through the respective cell compartments of all the cells of the stack, comprising
two identical parallelepiped elastomer gaskets defining a central aperture and having two or more through holes on said opposite perimeter sides thereof, a flat perimeter seal surface on a backside and on the opposite or front side thereof: a bas-relief patterned perimeter seal area contouring one through hole every two on said opposite perimeter sides, and similar pluralities of patterned short seal areas over said opposite perimeter sides, defining there between intermixing flow channels, leading the electrolyte solution from a rim region of non-contoured through holes to the nearest juxtaposed side of said central aperture and vice versa, respectively;
planar conductive bipolar electrodes or interconnects having through holes matching with the through holes of the gaskets counter opposed to it over opposite sides sealing there between an anode flow compartment and a cathode flow compartment communicating with preceding and with following anode and cathode flow compartments, respectively, of adjacent bipolar cells though said contoured through holes in said two perimeter sides of the gaskets;
said permionic membrane having perimeter edge portions sealingly held between said flat perimeter seal surfaces on the back side of the identical gaskets, disposed back-to-back;
said bas-relief patterned seal areas over the front side of the two identical gaskets compressed between the surfaces of respective planar electrically conductive bipolar elements having through holes in alignment with the through holes of the gaskets for hydraulically sealing the perimeter of the two flow compartments each communicating with respective preceding and following compartments of adjacent cells through said non contoured holes of the respective gasket.

8. The frameless multi-cell bipolar electrochemical reactor of claim 1 used in a redox flow battery system, wherein the assembly of stackable elements between two end headers, hydraulically sealed by compressing the stacked elements is segmented by comprising a certain number of intermediate headers coupled at both sides as would-be end headers of groups of bipolar cells on one side and on the opposite side thereof and having inlets and inner ducting for allowing the two electrolyte solutions to be flown in parallel through the respective compartments of one group of bipolar cells and exit the stack from outlets of a successive intermediate header; said two end headers and intermediate headers connecting through primary manifolds external to the stack, from and to respective electrolyte solution source and sink tanks.

9. The frameless multi-cell bipolar electrochemical reactor of claim 8, wherein each group of bipolar cells are in number adapted to generate a maximum open circuit total voltage lesser than a critical voltage that would cause excessively large ion discharge current densities on conductive parts of the cells of a group sharing internal manifolds of distribution of the two electrolyte solutions into respective flow compartments of the cells.

10. The frameless multi-cell bipolar electrochemical reactor according to claim 1, wherein each header comprises a parallelepiped body having defined in it two chambers or ducts hydraulically connectable to external pipes and at least a planar conductive bipolar interconnect applied onto a planar surface of the parallelepiped body and having through holes aligned with holes in said body communicating respectively with said chambers or ducts.
